(19) United States
(12) Patent Application Publication
(10) Pub. No.: US 2006/0242590 A1
(43) Pub. Date: Oct. 26, 2006

(54) Simple content format for auxiliary display devices

(75) Inventors: Daniel J. Polivy, Seattle, WA (US); Sriram Viji, Seattle, WA (US); Andrew J. Fuller, Redmond, WA (US); Matthew P. Rhoten, Kirkland, WA (US); Niels van Dongen, Seattle, WA (US); Richard J. Swaney, Sammamish, WA (US)

Correspondence Address: LAW OFFICES OF ALBERT S. MICHALIK;C/O MICROSOFT CORPORATION, 704 - 228TH AVENUE NE, SUITE 193, SAMMAMISH, WA, 98074, US

(73) Assignee: Microsoft Corporation, Redmond, WA (US)

(21) Appl. No.: 11/112,456

(22) Filed: Apr. 21, 2005

(51) Int. Cl. G06F 9/00

(52) U.S. Cl. 715/760; 715/866; 715/765; 715/764

(57) ABSTRACT

Described is a system and method comprising a content format by which client programs running on a main computer system may provide data to various types of auxiliary display devices. The format, which may be XML-based, provides menu pages comprising a list of selectable items, content pages comprising text and images, and dialog pages providing text, images and one or more actionable options. The text and images may be accompanied by requested formatting information, e.g., specifying emphasis, color, alignment, wrapping and/or fit to the screen. An auxiliary device can parse the content to display as much as possible, particularly information recognized (via content tags) as significant, and use the formatting information to the extent of its capabilities. Virtual buttons may be defined for page navigation and/or item selection. Pages of the content format may be cached for operation when the main computer system is offline from the auxiliary display device.

### COPYRIGHT DISCLAIMER

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD OF THE INVENTION

The invention relates generally to computer systems, and more particularly to a system and method for communicating information between a computer system and an auxiliary display device.

### BACKGROUND OF THE INVENTION

U.S. patent applications Ser. Nos. 10/429,930 and 10/429,932 are generally directed towards the concept of computer systems having auxiliary processing and auxiliary mechanisms that provide some auxiliary computing functionality to a main computer system. For example, a small LCD on the lid or side of a laptop computer can provide a user with useful information, such as a meeting location and time, even when the main computer display is not easily visible, e.g., when a laptop computer's lid is closed and/or the main computer is powered down. Controls such as a set of user-selectable responses or supported actions, such as in the form of buttons, may be provided to allow the user to interact with the auxiliary device, such as to choose a response to a notification, view different types of data, scroll through appointments among calendar data, read email messages, read directions, and so forth.

Somewhat similar to an auxiliary LCD screen built into a mobile host computer is a mobile telephone, a music playing device, a pocket-sized personal computer, a personal digital assistant or the like, which can each serve as an auxiliary device to a main computer system when coupled to it, such as physically and/or via a wireless (e.g., Bluetooth or infrared) link, or at any point after having been coupled to the computer, if the device persists data from the computer, as long as the device is programmed to allow its display and/or other functionality to be leveraged by the main computer. In general, any device with I/O capabilities that can interface in virtually any way with a computer system can potentially serve as an auxiliary computing device.

However, while there are potentially many varieties of devices that can serve as an auxiliary display for a computer system, at present, each of these devices has a custom way to interact with a main computer system. For example, the communication method, protocol and software may be different for each device. A significant problem is that there are far too many types of devices and computer programs that run on the main computer system. It is not feasible for application programmers and device manufacturers to provide custom connection methods for each combination. For example, different devices possess different graphical and processing capabilities and have different form factors, and a computer program cannot be adapted for every such device; there is no easy way for an application program on the main computer system to consistently show its data on such a varied set of devices. What is needed is a way for programs running on the main computer system to provide data to various types of auxiliary displays, regardless of the differences between various device implementations, such that the program's data is displayed in a way that gives users a consistent viewing and interaction experience.

### SUMMARY OF THE INVENTION

Briefly, the present invention provides a system and method comprising a content format by which client applications (i.e., programs running on the main computer system) may provide data to various types of auxiliary displays, irrespective of differences and/or capabilities between various device implementations. To this end, a format for sending data for rendering in a basic form is described, wherein the format provides for including some indication as to the purpose of displaying the data, various information that indicates what each item of data is, how the data is to be formatted, and possibly additional information. As a result, any device can process the data to render content to the extent of its capabilities, e.g., by knowing which parts are most important if limited output is required, and/or by handling the formatting of the rendered content in a way that the device is capable of accomplishing.

In one implementation, the basic content format is XML-based, making it straightforward to create and parse. The content format may be persisted in a storage medium, and functions in an online (coupled to a computer system) environment and offline (cached) environment. In this exemplary implementation, programs may provide data to render in menu pages, content pages, and dialog pages. A menu page provides a list of selectable items to the user. A content page displays text and images. A dialog page is a specialized version of a content page that provides the user with at least one actionable option, e.g., a button.

Text and image references may be included in the page. The text and images may be accompanied by requested formatting information, e.g., text may be emphasized (e.g., bolded), colored, aligned, wrapped and/or fit to the screen. Images may be formatted, e.g., aligned, and/or fit to the screen. Devices can ignore or override the formatting as necessary, typically in accordance with their capabilities.

The content format includes the concept of “virtual buttons,” comprising program-defined navigation-oriented buttons, to which each device can map its hardware buttons to the extent possible. In general, this will provide a consistent user navigation experience across devices having varying button capabilities.

A user may make selections and navigate among pages via the virtual buttons. In an offline scenario, this requires caching pages. In an online scenario, the main computer receives navigation events and can control the displayed page. Each navigation event may contain information such as the ID of the current page, the virtual button that was pressed, and an “action” and/or target ID, corresponding to another page or the like to navigate to and thus render. By monitoring these navigation events, a client application is able to effect actions on the main computer system, based on the user selecting menu items, or pressing buttons while displaying pages or dialogs. For example, as a page is received at the auxiliary device, a parser process the page and passes corresponding drawing instructions to a renderer that renders the page. The page may be cached. Upon a navigation event, the main computer system and/or a cache manager on the auxiliary device provide a requested new page. The new page may be an updated version of the previous page, e.g., the target ID is that same as the previous page ID.

Other advantages will become apparent from the following detailed description when taken in conjunction with the drawings, in which:

### BRIEF DESCRIPTION OF THE DRAWINGS

FIG. 1 is a block diagram representing a general purpose computing device in the form of a conventional personal computer system into which the present invention may be incorporated;

FIGS. 2A-2E are exemplary illustrations generally representing locations for placement of the auxiliary display on various devices;

FIG. 3 is a block diagram generally representing an example layered architecture by which client applications can exchange data with the firmware of an arbitrary auxiliary display device using the simple content format, in accordance with various aspects of the present invention;

FIG. 4 is a block diagram generally representing how navigation is accomplished using the simple content format, in accordance with various aspects of the present invention;

FIG. 5 is an example representation of data in the form of a menu page being provided to different auxiliary display devices, in accordance with various aspects of the present invention;

FIG. 6 is an example representation of data in the form of a content page being provided to different auxiliary display devices, in accordance with various aspects of the present invention; and

FIG. 7 is an example representation of data in the form of a dialog page being provided to different auxiliary display devices, in accordance with various aspects of the present invention.

### DETAILED DESCRIPTION

Exemplary Operating Environment

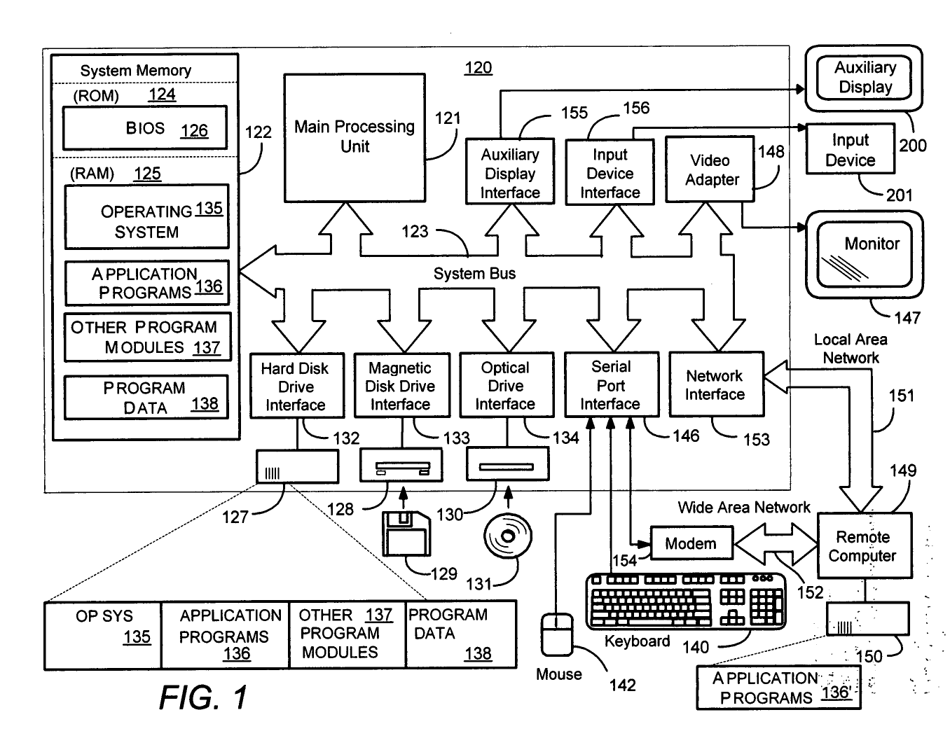

FIG. 1 is a block diagram representing a computing device 120 in the form of a personal computer system into which the present invention may be incorporated. Those skilled in the art will appreciate that the personal computer system 120 depicted in FIG. 1 is intended to be merely illustrative and that the present invention may be practiced with other computer system configurations, including hand-held devices, multi-processor systems, microprocessor-based or programmable consumer electronics, network PCs, minicomputers, mainframe computers, headless servers and the like. The invention may also be practiced in distributed computing environments where tasks are performed by remote processing devices that are linked through a communications network. In a distributed computing environment, program modules may be located in both local and remote memory storage devices.

The personal computer system 120 includes a processing unit 121, a system memory 122, and a system bus 123 that couples various system components including the system memory to the processing unit 121. The system bus 123 may be any of several types of bus structures including a memory bus or memory controller, a peripheral bus, and a local bus using any of a variety of bus architectures. The system memory includes read-only memory (ROM) 124 and random access memory (RAM) 125. A basic input/output system 126 (BIOS), containing the basic routines that help to transfer information between elements within the personal computer 120, such as during start-up, is stored in ROM 124. The personal computer 120 may further include a hard disk drive 127 for reading from and writing to a hard disk, not shown, a magnetic disk drive 128 for reading from or writing to a removable magnetic disk 129, and an optical disk drive 130 for reading from or writing to a removable optical disk 131 such as a CD-ROM or other optical media. The hard disk drive 127, magnetic disk drive 128, and optical disk drive 130 are connected to the system bus 123 by a hard disk drive interface 132, a magnetic disk drive interface 133, and an optical drive interface 134, respectively. The drives and their associated computer-readable media provide non-volatile storage of computer readable instructions, data structures, program modules and other data for the personal computer 120. Although the exemplary computer system described herein employs a hard disk, a removable magnetic disk 129 and a removable optical disk 131, it should be appreciated by those skilled in the art that other types of computer readable media which can store data that is accessible by a computer, such as magnetic cassettes, flash memory cards, digital video disks, Bernoulli cartridges, random access memories (RAMs), read-only memories (ROMs) and the like may also be used in the exemplary computer system.

A number of program modules may be stored on the hard disk, magnetic disk 129, optical disk 131, ROM 124 or RAM 125, including an operating system 135 (such as Windows® XP), one or more application programs 136 (such as Microsoft® Outlook), other program modules 137 and program data 138. A user may enter commands and information into the personal computer 120 through input devices such as a keyboard 140 and pointing device 142. Other input devices (not shown) may include a microphone, joystick, game pad, satellite dish, scanner or the like. These and other input devices are often connected to the processing unit 121 through a serial port interface 146 that is coupled to the system bus, but may be connected by other interfaces, such as a parallel port, game port or universal serial bus (USB). A monitor 147 or other type of display device is also connected to the system bus 123 via an interface, such as a video adapter 148. In addition to the monitor 147, personal computers typically include other peripheral output devices (not shown), such as speakers and printers. An auxiliary display 200 is an additional output device, and may, for example, be connected to the system bus 123 via an auxiliary display interface 155. An auxiliary display 101 may also connect to a computing device 120 through a serial interface or by other interfaces, such as a parallel port, game port, infrared or wireless connection, universal serial bus (USB) or other peripheral device connection. An input device 201 in FIG. 1 may provide one or more actuators to interface with and/or control the auxiliary display 200, and for example may be part of the auxiliary display device, but alternatively may be independent thereof and connected to the system bus 123 via input device interface 156, which may be a serial interface, or by other interfaces, such as a parallel port, game port, infrared or wireless connection, universal serial bus (USB) or other peripheral device connection.

The personal computer 120 may operate in a networked environment using logical connections to one or more remote computers, such as a remote computer 149. The remote computer 149 may be another personal computer, a server, a router, a network PC, a peer device or other common network node, and typically includes many or all of the elements described above relative to the personal computer 120, although only a memory storage device 150 has been illustrated in FIG. 1. The logical connections depicted in FIG. 1 include a local area network (LAN) 151 and a wide area network (WAN) 152. Such networking environments are commonplace in offices, enterprise-wide computer networks, Intranets and the Internet.

When used in a LAN networking environment, the personal computer 120 is connected to the local network 151 through a network interface or adapter 153. When used in a WAN networking environment, the personal computer 120 typically includes a modem 154 or other means for establishing communications over the wide area network 152, such as the Internet. The modem 154, which may be internal or external, is connected to the system bus 123 via the serial port interface 146. In a networked environment, program modules depicted relative to the personal computer 120, or portions thereof, may be stored in the remote memory storage device. It will be appreciated that the network connections shown are exemplary and other means of establishing a communications link between the computers may be used.

It should be noted that the computer system need not be fully operational for an auxiliary device to work in accordance with the present invention. Indeed, an auxiliary device may still work when the computer is powered down, at least to a default extent or to an extent configured by a user, such as when the computer system is in a sleep state or a hibernate mode, and/or when the user has not yet logged on or is otherwise locked out of the system via security mechanisms.

The auxiliary device may supplement the main display and may also serve as a surrogate display when the main display is shut down or otherwise not operational (e.g., disconnected), to give the user some information. For example, information such as how to power up the main display might be helpful, as would a room number and/or directions to a meeting on an auxiliary display device connected to a mobile computer that the user can view when the main display is off and/or not easily visible (e.g., the lid of a laptop is closed). The auxiliary device may play audio and/or video, show images, show calendar information, show emails and so forth.

To enable and control communication in these powered-down modes, firmware may exist, stored in non-volatile memory, which when loaded and operated on by a secondary processor, enables the auxiliary display, along with other auxiliary components to be used, as long as some power is available. Note that as used herein, the terms “firmware” and “device hardware” are essentially equivalent, and can be generally considered as representing the auxiliary memory, the code therein and/or the secondary processor on which it runs.

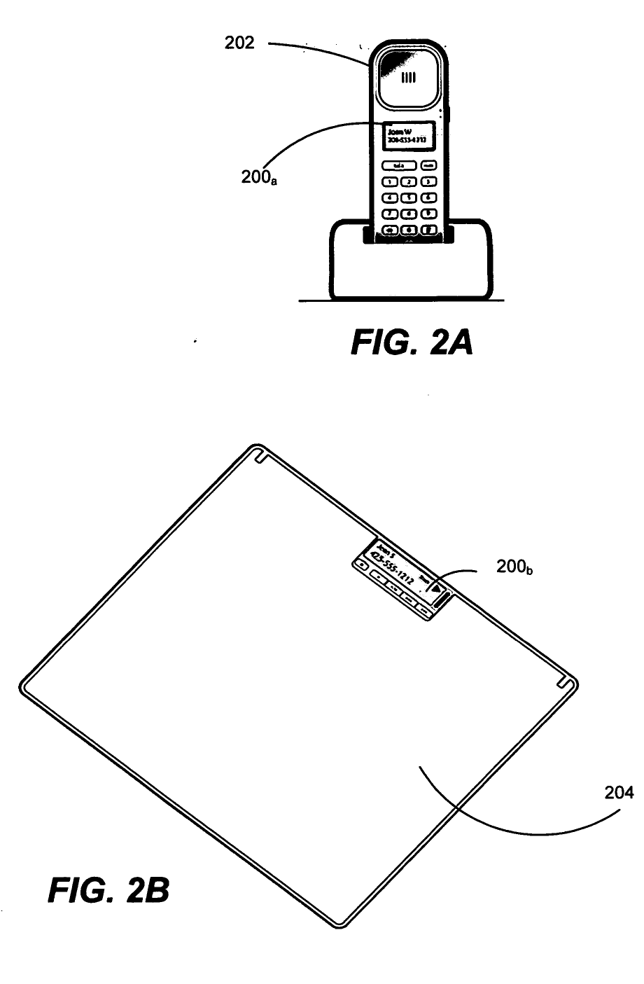

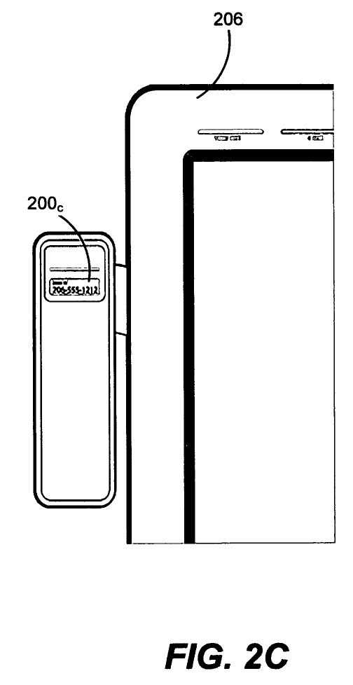

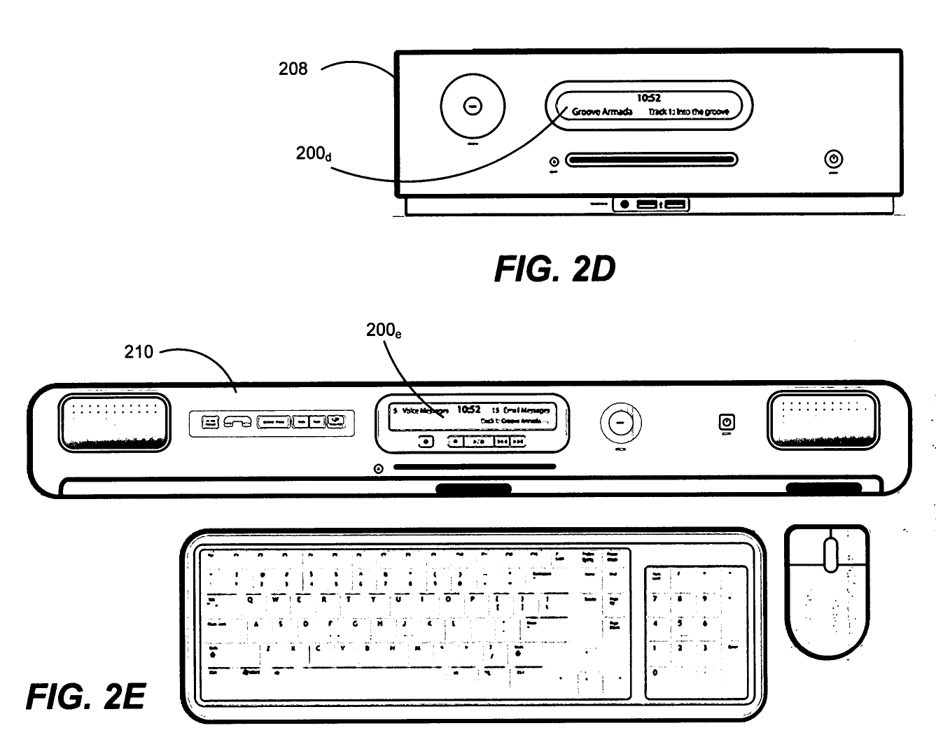

FIGS. 2A-2E illustrate exemplary locations on or associated with computing devices for placement of auxiliary display screens 200ₐ-200ₑ, respectively. As represented in FIGS. 2A and 2B, an auxiliary display screen 200ₐ may be placed on the front, back or other surface of a standalone (landline or mobile) phone 202, (which need not be physically coupled if otherwise linked such as via Bluetooth technology) and/or another auxiliary display screen 200_{b} placed on the edge or lid of a mobile computer 204 or tablet computing device (not shown). Another place for an auxiliary display screen 200_{c} (FIG. 2C) may be on a phone mounted on a computer or a peripheral device attached to a computer such as on monitor 206 or on a keyboard (not shown). FIGS. 2D and 2E illustrate additional placements of auxiliary display screens 200_{d} and 200ₑ on the front panel of a standalone console 208 connected to a computer, or some other housing 210 (such as a housing for the motherboard), respectively. Those skilled in the art will appreciate that an auxiliary display screen may be placed on any surface of any computing device or other device having display capabilities, such as placed on a watch with a wireless or other connection to a computer, on a remote control device, on a remote wall-mounted unit, and so forth. Indeed, the auxiliary display need not be physically close to the main computer system, as the connection may be over a LAN or WAN, or even over the internet.

As should be apparent from FIGS. 2A-2E, an auxiliary display may be in the form of any number of known types of displays such as one or more LEDs, a 2-line alphanumeric display, a monochrome display, or a color display. Those skilled in the art will appreciate that the present invention may also use the display of other computing or communication devices as the auxiliary display 200. These other computing or communication devices include general purpose computers, cell phones, and handheld devices such as a pager or a personal digital assistant (PDA). Additionally, the present invention may use a virtual auxiliary display implemented within an area of the onscreen display of the computing device 120 (e.g. a screensaver or a component of the graphical user interface) as the auxiliary display 200, including before a user has logged in. The auxiliary display 200 may include a combination of any of the forms described above, and also be physically or logically combined with indicators such as one or more LEDs and/or used in conjunction with a virtual auxiliary display.

An auxiliary device may provide functionality even without a screen, or when its screen is powered down. For example, an auxiliary device may play audio, collect data (e.g., for later download to the main computer), perform calculations and so forth. Also, the display may comprise one or more LEDs or the like rather than a full screen. Thus, although many benefits and advantages arise from having an auxiliary display screen, and thus an auxiliary device may be referred to herein as an auxiliary display, a display is not required. In general, an auxiliary display, as referred to herein, may be composed of essentially anything that can be sensed, including any visual, audible, and/or tactile representations.

Simple Content Format for Auxiliary Display Devices

The present invention is generally directed towards providing data such as in the form of menu pages, content pages, dialog pages and other information for display on an auxiliary display device. When appropriate, the pages are changed based upon returned information from the device, such as events based on user interaction with the auxiliary device. However, while the present invention is generally described with reference to menu pages, content pages, dialog pages, it will be readily apparent that the present invention is not limited to pages, nor to these particular types of pages, and that the data may be arranged in various ways, including sub-pages such as pop-ups, or data that is not even in a page-based arrangement.

As will be understood, there are many types of devices that can serve as an auxiliary display device, including those that do not necessarily have displays but can provide some output such as a sound or light. Although a number of examples are used herein, including displays on laptop lids, mobile phones, pocket-sized personal computers, digital image-based picture frames, kitchen displays, televisions, media players, clocks including alarm clocks, watches and so forth, the present invention is not limited to any of these examples, but rather anticipates the use of any device capable of outputting sensory information, even when referred to as an auxiliary “display.” For example, other types of devices include auxiliary devices embedded within or using the main display of a consumer electronics device (such as a refrigerator, home theater receiver, DVD player, and so forth), wall displays, automotive, transportation or other vehicular units (e.g., using displays already in a car/train/plane as an auxiliary display), keyboards or other input devices of the main computer system, PDAs (including non-cellular telephone PDAs), and the like. Similarly, the present invention is not limited to any particular mechanism for coupling the auxiliary display to another computer system, and thus is not limited to the wired or wireless examples used herein. The connection may be relatively close or relatively distant, essentially anywhere, such as over a LAN or WAN, or over a virtual private connection over the Internet.

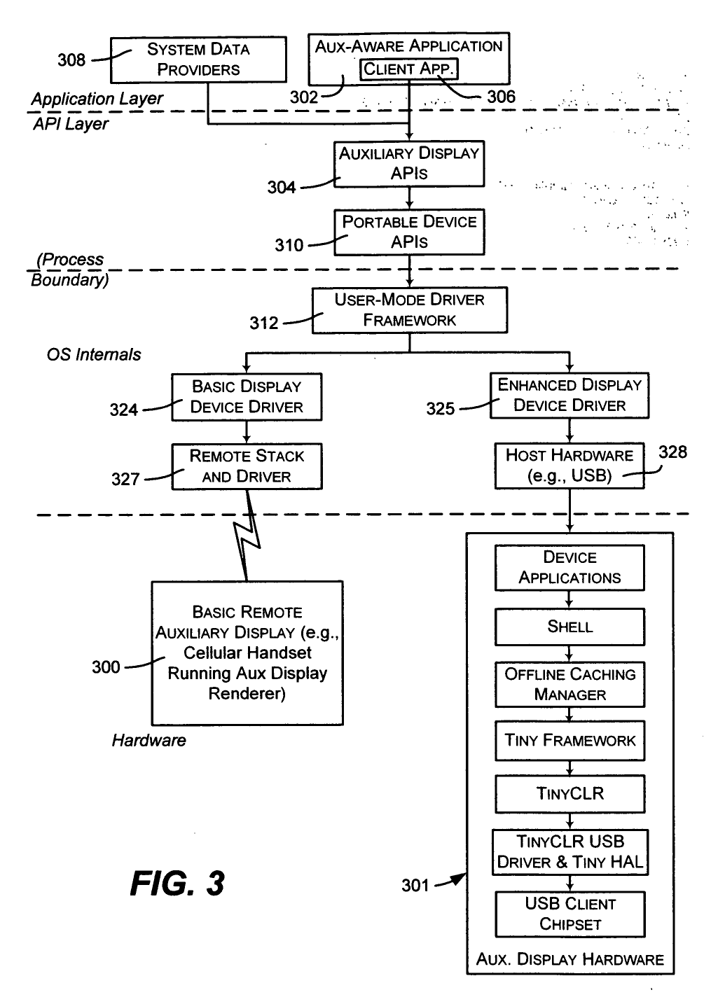

Turning to FIG. 3 of the drawings, there is shown an example architecture that exposes one or more auxiliary devices (e.g., 300 and 301) to clients comprising applications 302 and other programs (e.g., operating system components) via an auxiliary display API set 304. In one exemplary implementation, the API set 304 is in the form of C++ accessible COM APIS. The API set 304 provides APIs for various functions, including registering a client application 306 (a component of the program or possibly the program itself) with the system, sending content to the attached devices, sending notifications to the attached devices, and receiving events from the attached devices. Events may include navigation events, content request events, content change events, and so forth.

The use of the API set 304 exposes only an “auxiliary display system” to the clients that use the API set 304; other (non-API) access to individual devices is feasible, but not necessary. As a result, for an independent software vendor, after registering a program component as a client application (via the API set 304), content may be sent to any auxiliary device using another call to the same API set 304, regardless of the device's actual type and capabilities. Although the user experience may differ, the application need not adapt to the auxiliary device that is present. Note that while an application may also obtain capability information about the auxiliary device, and may choose to act differently based on the capabilities, the application need not do so in order to use the device. This is because the present invention provides a simple content format that allows the device to handle the content in accordance with its own capabilities, freeing the application from complex tasks, including tailoring data to any particular device.

The API layer 304 is written on a portable device API set 310, which communicates with the device's driver process via a user-mode driver framework 312. The portable device API set 310 enables connection to portable devices such as MP3 players, digital cameras and so forth, and is leveraged by auxiliary displays. The portable device API set 310 maps the auxiliary display into a category of portable devices, and it allows enumeration of the device's capabilities.

In general, the client application 306 sends data for outputting, such as content and notifications, to the auxiliary device. The device is capable of displaying notifications, as well as generating its own notifications (e.g., at some scheduled time) based on the data provided from the main computer system. The device provides information back to the client application 306 in the form of events. Note that the components below the application layer and above the device drivers 324 and 325 may be generally referred to as the “auxiliary display platform.”

As shown in FIG. 3, multiple devices may be coupled to a computer to serve as an auxiliary display at the same time. A user may configure (e.g., via a control panel or the like) which client applications' data are displayed on which devices. A system data provider 308 may also supply system information such as time data, wireless signal strength data, the computer's audio volume and mute state, and/or battery level data to auxiliary displays. In one implementation, the auxiliary display platform consults a system-maintained matrix whenever a client application 306 sends content, to determine which device or devices are to receive the information. The API set 304 of the auxiliary display platform will also send events (and possibly other information) from auxiliary devices to the client application 306, again using the matrix to route the events back to the client application (or client applications) as appropriate.

Certain types of auxiliary devices, such as the display 301 in FIG. 3, are considered “enhanced” displays because they are configured with certain SPOT (Smart Personal Object Technology) firmware and certain rendering code, and among other things are generally compatible with any information that can be received via the API set 304. Other auxiliary devices, referred to herein as “basic” displays, comprise any auxiliary display device that runs other custom firmware but is capable of acting as an auxiliary display, e.g., the basic remote auxiliary (cellular handset) display 300 of FIG. 3. The user mode driver framework provides a device driver interface (DDI) for coupling device drivers (e.g., 324 and 325) to the auxiliary display platform. The drivers then forward data corresponding to the API-received information to an appropriate hardware interface (transport) for communication to the auxiliary display device. For example, in FIG. 3, the basic device driver 324 is shown as forwarding data (via a previously defined protocol) to the remote stack and driver 327 for wireless (e.g., Bluetooth, Wi-FI, AM/FM infrared and so forth) communication to the device 300, whereas the enhanced device driver 325 is shown as forwarding data to USB-based hardware 328, although other types of transports including network transports such as TCP/IP-based transports are feasible. As is understood, these connections are only shown for example purposes, as any device driver will forward data for wireless or wired communication as appropriate.

One aspect of the present invention is directed towards providing application program developers with a mechanism for sending information to essentially any auxiliary display device. In one implementation, the mechanism includes an XML-based format for content to display. As will be understood, the format is simple to create and parse, allows the program to display the content in a manner that the auxiliary device scales up or down depending on its capabilities, and provides a consistent experience across a wide range of devices. Moreover, the content format may be persisted in a storage medium, and thus functions in an online (coupled to a computer system) environment and offline (cached) environment.

In one exemplary implementation, programs may provide data to render in one of three ways, which correspond to types of pages, namely menus, content pages, and dialogs. As described below, a menu page provides a list of items to the user, each of which is selectable; it is essentially a list box. A content page is comprised of typically static text and images, while a dialog is a specialized version of a content page that provides the user with at least one actionable option. In one example implementation, each type of page is mutually exclusive, that is, pages cannot be combined; however other types of pages are feasible, including those that allow combined pages.

As also described below, the content format includes the concept of “virtual buttons,” which are a set of common navigation-oriented buttons which may be defined. For example, one possible (but not comprehensive) list may include: home, up, down, left, right, select, menu, context and back buttons. Virtual buttons provide the program developer with a set of well-known buttons, to which each device can map its hardware buttons to the extent possible. In general, this will provide a consistent application navigation experience across devices having varying button capabilities. Note that some devices may include software buttons as part of the display, particularly those with touch screens. Also, part of the display may be used to label or map a hardware button, e.g., text such as “Up”, “Select” and “Down” each may be displayed near a corresponding hardware button to guide the user.

In general, a user may navigate within a page or among pages via the virtual buttons. In an offline scenario, this requires caching pages such that all of the pages the user navigates to are available in the cache. In an online scenario, when the main computer system is operating, each navigation event on the device causes an event to be sent to the main computer system. This event may contain information such as the ID of the current page, the virtual button pressed, and an “action” and/or target ID, corresponding to another page or the like to navigate to and thus render. By monitoring these navigation events, a client application is able to effect actions on the main computer system, based on the user selecting menu items, or pressing buttons while displaying pages or dialogs. Note that an event (e.g., a separate event) may be sent from the cache manager to fault in data from the main computer system, if necessary.

If known to be offline, a cache miss situation may still result in an event or the like being sent towards the main computer system, because, for example, such an event may be used to wake the main computer system when the reason that the computer is offline is that the main computer system is in a sleep state.

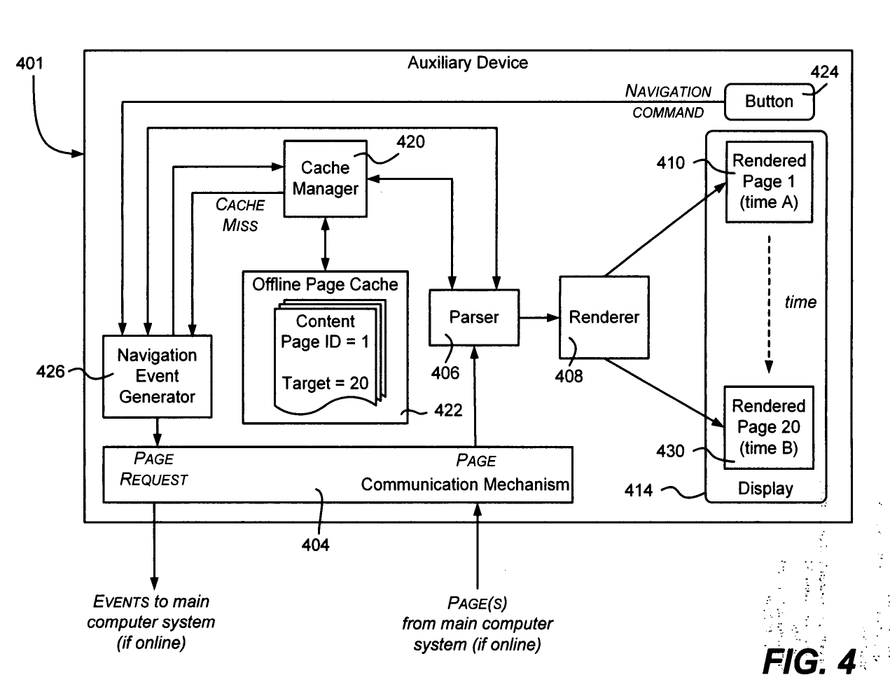

FIG. 4 shows a general way in which navigation may be handled in an auxiliary display device 401 in which content data formatted in accordance with the simple content format (e.g., as pages) is received at a communication mechanism 404. As a page is received, a parser 406 process the page and passes corresponding drawing instructions to a renderer 408 that renders the page to display data content, e.g., the rendered page 410 having an ID of 1 (shown drawn at a time A) on the display 414. The parser 406 (or other component) may also provide the page data to a cache manager 420 for persisting the page in an offline page cache 422 or the like.

The page may be interactive, e.g., a menu or dialog as described above, or static content that changes to another page. A button 424 (e.g., of a set of buttons) may be actuated, which a navigation event generator 426 (e.g., a driver) or the like receives and processes to send one or more events. For example, an event may be sent to the main computer system, and also to the cache manager 420. In this manner, the parser 406 may receive a new page to render; also, the main computer system can download data to the auxiliary device, such as to preload the cache in anticipation of a next page, or to load the memory with other content corresponding to the page, e.g., the next audio track. Note that in an online state, the parser 406 can disregard a page from the cache 422 (or request an updated one), or use the page in accordance with some policy, e.g., use if not expired. In a typical implementation, the cache manager 420 sends a cache miss event to the main computer system if a desired page is not cached, and can either receive and provide the page if the main computer system is online, or provide an error page or code if offline. Note that because the main computer system receives an event when online, it knows what is occurring at the auxiliary display, and can change a page as desired; in essence, the device will listen for a change in the currently displayed page and will automatically refresh.

In the example of FIG. 4, the target page is returned from the main computer system or cache 422, and is rendered as a page 430 on the display 414. Note that in FIG. 4, there is only one page shown on the display at a time; the second page rendered, having page ID 20, is shown as being displayed at a later time, time B.

For some applications, it may be desirable to stay on the same page for at least some of its button events, whereby the target ID for such a button is the same as that of the currently displayed page. This in effect behaves as a key press event being sent to the main computer system without causing any real navigation on the auxiliary display device. Note that when in an online state, the application program may change the content of a page even if the ID is not changed. Further, in some instances (e.g., for some virtual buttons), the program may not be allowed to override certain behaviors (such as a “back” or “menu” button) to ensure a consistent user experience.

Turning to an explanation of supporting elements that may be used on a page formatted according to the simple content format of the present invention, images may be provided, e.g., in one of a few image formats. A recommended image format such as JPG may be used as a default, however devices may support other image options, including GIF, PNG and BMP. The content format is extensible to support any current or future image types.

Within a page, in the XML-based format example, an “img” (image) tag is used to include an image, by referencing an image stored on or otherwise accessible to the auxiliary device. An “id” attribute contains the content identifier of an image to use. There is an implicit line break at the end of the img element. The following sets forth an example usage of the img tag in markup:

<img id=5 />
<img id=5></img>
<img id=5 align=”c” fit=”screen” alt=”[Full Screen Image]” />

The following table provides additional information about the properties of the img tag, in one example implementation:

| | | | |
|---|---|---|---|
| id | Number | Required | The content id of the image. This |
| | | | number represents the content id |
| | | | that contains the binary image |
| | | | data. |
| align | “l” | Optional | Can be “l” (Left), “r” (Right), or |
| | “r” | | “c” (Center). Specifies the |
| | “c” | | horizontal alignment of the image |
| | | | on the page. Note that the device |
| | | | does not have to respect this |
| | | | property. Only valid when used |
| | | | within a content or dialog page. |
| | | | Default: “l” |
| fit | “native” | Optional | Specifies how the image will be |
| | “width” | | rendered relative to the screen; |
| | “screen” | | “native”: specifies using the |
| | “auto” | | native resolution of the image, |
| | | | cropping the width as necessary |
| | | | “width”: specifies proportionately |
| | | | scaling the image to fit the |
| | | | available width of the screen |
| | | | “screen”: specifies proportionately |
| | | | scaling the image to fit the width |
| | | | and height of the screen without |
| | | | scrollbars |
| | | | “auto”: lets the device determine |
| | | | the best size for the image; this |
| | | | would allow the device to fit all |
| | | | content (text and images) on a |
| | | | single screen by adjusting the size |
| | | | of the image |
| | | | Default: “native” |
| Alt | string | Optional | Alternate text to be displayed in |
| | | | place of the image if necessary. |

The “txt” (text) tag is used to specify text on a page. In one implementation, the font used is determined by the device. There is an implicit line break at the end of each txt element. The following table provides information about the properties of the txt tag, in one example implementation:

| | | | |
|---|---|---|---|
| Align | “l” | Optional | Can be “l” (Left), “r” (Right), or |
| | “r” | | “c” (Center). Specifies the |
| | “c” | | horizontal alignment of the text |
| | | | on the page. Note that the device |
| | | | does not have to respect this |
| | | | property. |
| | | | Default: “l” |
| Wrap | 0, 1 | Optional | Specifies whether the text should |
| | | | wrap if it is longer than a single |
| | | | line. 0 means no (the text will |
| | | | be truncated to a single line) and |
| | | | 1 means yes (the text will wrap |
| | | | onto multiple lines) |
| | | | Default: 1 |
| Rgb | RGB | Optional | Specifies the RGB value of the |
| | value, | | color to use for text. The color |
| | specified | | is specified as 6 hex values, 2 |
| | as HHHHHH | | for each color. Note that the |
| | | | device does not have to respect |
| | | | this property. |
| | | | Default: device's default font |
| | | | color |

An example usage of the txt tag in markup is set forth below:

<txt>This is the default text.</txt>
<txt align=”c” wrap=”0”>Centered Text That Is
Truncated</txt>
<txt rgb=”0F0F0F”>This text is colored.</txt>

An “em” (emphasis) element may be used with text to specify that the text within the element should be emphasized. In one implementation, the emphasis format is up to the device, (such as bold, color, flashing, reverse video, and/or underline), however bold type is recommended. If a device cannot emphasize text with formatting, it may use pre- and post- characters to delineate the emphasized text. This tag is only valid within a txt element. It is also feasible to have different types of emphasis flags or sub-emphasis flags, e.g., emclr (emphasis color if possible), which the device can choose to handle, ignore, or treat as a regular emphasis.

An example usage of the em element within a txt tag in markup is set forth below:

<txt>This text is <em>emphasize</em>!</txt>

The “cdr” (color) element specifies that the text within the cdr element should be a specific color. Note that this refers to the text foreground color, however in alternative implementations it is straightforward to allow the program to specify a background color as well. The device should choose a color closest to that specified in the content. If a device cannot support color, it can use other methods of differentiating the text, or it can do nothing. This tag is only valid within a txt element.

An example usage of the clr element within a txt tag in markup is set forth below:

<txt rgb=”FFFFFF”>White Text <clr rgb=”000000”>Black
Text</clr> White Text</txt>

The following table provides information about the properties of the cdr element, in one example implementation:

| | | | |
|---|---|---|---|
| rgb | RGB | Required | Specifies the RGB value of the |
| | value, | | color to use for text. The color |
| | specified | | is specified as 6 hex values, 2 |
| | as HHHHHH | | for each color. Note that the |
| | | | device does not have to respect |
| | | | this property. |

The “br” (break) element specifies that a line break should occur at the specified point. The element should be specified as “<br/>” (though <br></br> is still legal). It may be used in a menu item to cause it to wrap to multiple lines. An example usage of the br element within txt and item tags in markup is set forth below:

<txt>Text block 1</txt><br/><txt>Text block 2</txt>
<txt>Line 1<br/>Line2</txt>
<item target=10>Line 1<br/>Line2</item>

The “btn” (button) element specifies the actions that occur when a button is pressed. The text of the button is specified in the element's text section (and is not necessarily visible, but may be used in a help screen or software button). The button may be mapped to one of a predefined number of virtual buttons, and they may cause navigation to the specified page ID as described above. The following is an example of the btn element usage:

<btn target=”10” key=”right”>Forward</btn>

The following table provides information about the properties of the btn element, in one example implementation:

| | | | |
|---|---|---|---|
| target | Number | Required | The ID number of the page to |
| | | | navigate to on selection of the |
| | | | button. |
| key | ”left” | Required | The virtual key to map to this |
| | “right” | | button. A small set of virtual |
| | “up” | | keys that are representative of |
| | “down” | | common buttons on most devices is |
| | “enter” | | defined. An example list may |
| | “menu” | | include: Enter, Back, Home, Left, |
| | “home” | | Right, Up and/or Down. It is up to |
| | “back” | | the software on the device to map a |
| | etc. | | physical button into a virtual |
| | | | button. When the virtual button |
| | | | specified in the Button element is |
| | | | pressed, it prompts a navigation to |
| | | | the page specified by target. |

Turning to examples of types of pages, a menu page comprises a collection of ordered menu items. The items are intended to be displayed in the order in which they are declared, however a given auxiliary device may display them otherwise. A title, if provided, will be shown at the top of the menu, and may, for example, be offset in some way, such as via a larger font, different default alignment, an automatic div (divider) element, and so forth. In the example implementation described herein, each menu item can reference an image to be displayed next to the item, an ID for that menu item (to uniquely identify it within that page), an ID to navigate to on selection of that item and text to be displayed for that item. To be displayed, the icon needs to be provided in a supported image format. The format, size and color depth will be determined based on the capabilities of the device, subject to some limits. Images are referenced by their content ID.

The following table details example properties of a menu page:

| | | | |
|---|---|---|---|
| Id | Number | Required | The ID number of the current page. |
| | | | This is for reference only. |
| Title | String | Optional | The title to be displayed in the |
| | | | title bar or at the top of the |
| | | | page. |
| | | | Default: no title |

The menu element contains a list of item children; the item element describes a single item in the menu, and each item element contains the text for the item within the tag. In one example implementation, the font is determined by the device. The following table sets forth example properties for items:

| | | | |
|---|---|---|---|
| target | Number | Required | The ID number of the page to |
| | | | navigate to on selection of the |
| | | | item. |
| id | Number | Optional | The ID number of the menu item. It |
| | | | is only required to be unique |
| | | | within the menu in which it |
| | | | resides. |
| imgid | Number | Optional | The content id of the Image to be |
| | | | used as an icon for the item. The |
| | | | size of the rendered image is |
| | | | determined by the device. The |
| | | | images are rendered to the left of |
| | | | the text in the menu item. |
| def | 0, 1 | Optional | If value is “1”, indicates that |
| | | | this item should be the default |
| | | | selected item in the menu. Note |
| | | | that if this is specified on |
| | | | multiple item elements, the first |
| | | | one to specify it is the default |
| | | | item. If it is not specified, the |
| | | | first item is the default item. |
| | | | Default: 0 |
| enable | 0, 1 | Optional | If value is “1”, indicates this |
| | | | item is enabled. If value is “0”, |
| | | | indicates the item is disabled. |
| | | | This means it should either be a) |
| | | | rendered greyed out and non- |
| | | | interactable, or b) not rendered at |
| | | | all. |
| | | | Default: 1 |
| menuid | Number | Optional | If specified, contains the content |
| | | | ID of the Menu page which acts as a |
| | | | context menu for this item. This |
| | | | allows for per-item context menus. |
| | | | Note that it is ignored on menus |
| | | | which are used as context menus. |
| | | | An example is selecting a document, |
| | | | actuating the context button, and |
| | | | seeing a menu with options for that |
| | | | document such as Print, Save and |
| | | | the like. |

The “div” (divider) element inserts a dividing line in the menu. It has no additional properties, and may not be supported by all devices.

The following is an example of how a menu page may be specified:

```
<body>
    <menu id=”100” title=”Main Menu”>
        <item target=”5” imgid=”1” menuid=”200”>Media</ item>
        <item target=”6” imgid=”2” def=”1”>Calendar</item>
        <item Target=”7”>E-mail</item>
        <div/>
        <item Target=”8” enable=”0”>Settings</item>
    </menu>
</body>
```

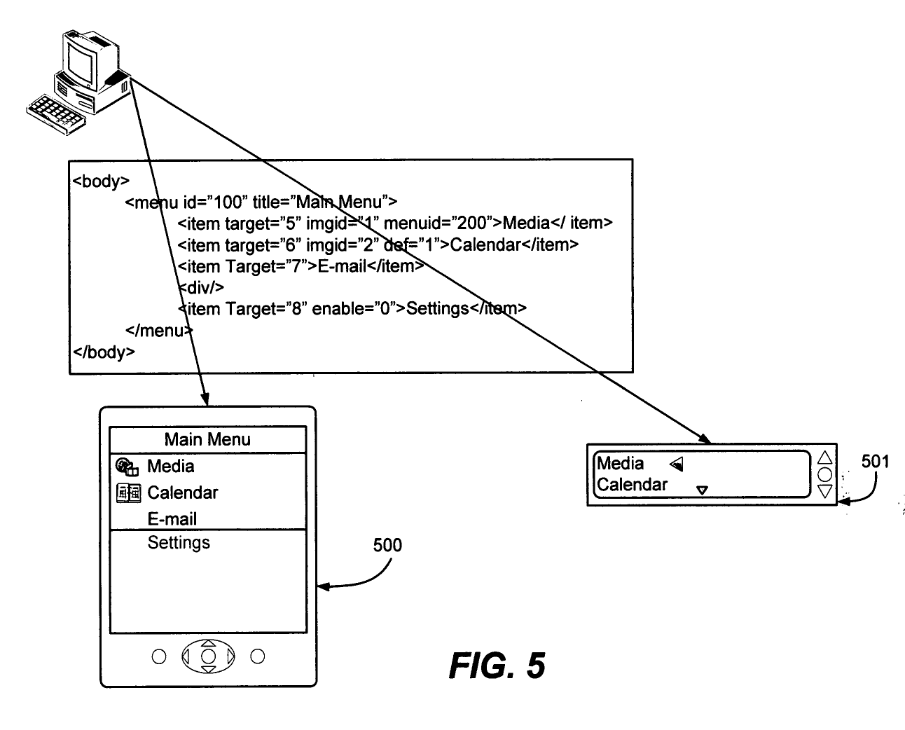

FIG. 5 is a representation of how this menu page may be rendered on different auxiliary devices 500 and 501. As can be seen, the auxiliary device 500 is capable of rendering essentially everything specified on the menu page, without scrolling, including the graphics (images and dividers) and text. Although buttons are not shown, a selection may be made by changing pages to provide the effect of a cursor or the like moving with a button, by an actual cursor that overlays the page being controlled by a button, and/or detecting coordinates on a pen/touch-sensitive screen.

Note that the two-line display 501 has lesser capabilities, such as the inability to display the specified images, and the ability to display only two lines of text at once. Substitute text may be specified in place of an image for devices that cannot display the image, however in this example, none has been specified. Significantly, via the tags, the device 501 is able to differentiate the title from the items to display and scroll among. While the title may be displayed if scrolled fully to the top, the device can elect to not display it, or at least not initially. In general, by putting useful information in the first line of a menu item, a program can ensure that a device which may only be able to display the first line of text in a menu item will (likely) do so. Further, as represented in FIG. 5, the currently selected menu item may be shown as such (e.g., at the top if necessary) and the device supports it; other menu items that do not fit should be truncated.

Another type of page is a content page, comprising a collection of static text and images. Formatting of the layout is done in a “flow” manner, in which text wraps automatically at the screen limit. Line breaks can be specified, as can text alignment hints, however they do not have to be respected by the devices. Note that while content pages are static in one implementation, in alternative implementations, animation may be specified and provided, the device may retrieve and render variable content such as stock quotes that regularly update within a page, and/or entire pages may be automatically looped to give the appearance of automation.

The “content” tag indicates that the content is a content page. In one example implementation, the content tag can contain only txt, img, br and/or div tags beneath it. The following sets forth example properties for a content page:

| | | | |
|---|---|---|---|
| id | Number | Required | The ID number of the current page. |
| | | | This is for reference only. |
| title | String | Optional | The title to be displayed in the |
| | | | title bar or at the top of the |
| | | | page. |
| | | | Default: no title |
| bg | Number | Optional | A reference to an Image which is |
| | | | used as the background for this |
| | | | page. Note that the device does |
| | | | not have to respect this property. |
| | | | Default: no background image |
| bgfit | “s” | Optional | Determines how the background image |
| | (scale), | | will be laid out. Possible options |
| | “t” | | are “Scale”, “Tile”, “Center”. |
| | (tile), | | Default: “s” (Scale) |
| | “c” | | |
| | (center) | | |
| menuid | Number | Optional | If specified, contains the content |
| | | | ID of the Menu page which acts as |
| | | | the context menu for this page. |

The following example markup shows a page that may be rendered:

```
<body>
    <content id=”200” title=”Now Playing” bg=”50” bgfit=”s”
    menuid=”1000”>
        <txt align=”c” wrap=”0”><em>Song Title</em></txt>
        <br/>
      <txt align=”c” wrap=”0”>Song Artist</txt>
      <br/>
      <txt align=”c” wrap=”0”>00:00:00</txt>
      <br/>
      <img align=”1” id=”1” alt=”Album Art”/>
    </content>
</body>
```

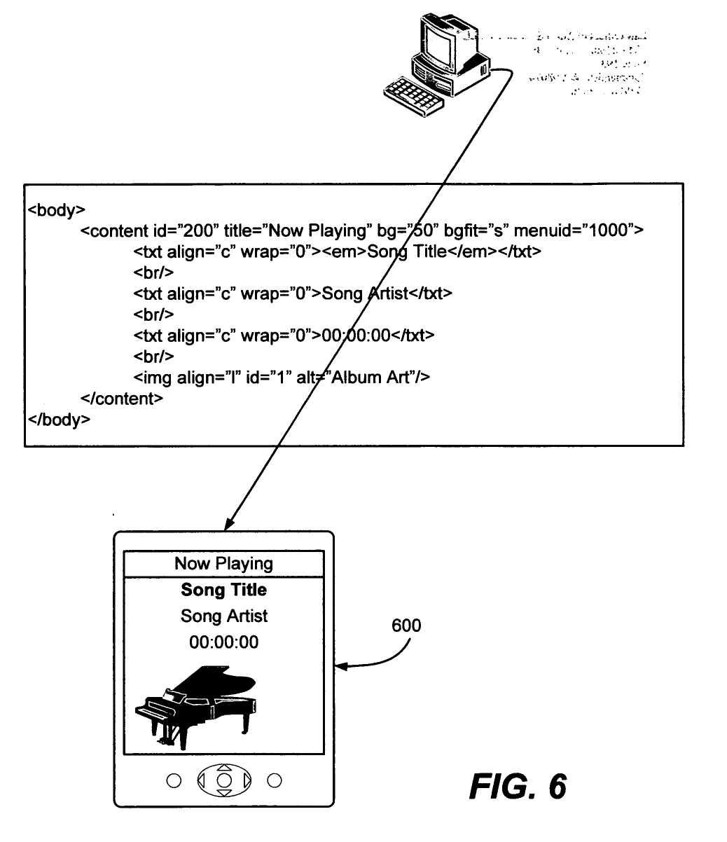

FIG. 6 shows one possible way in which an auxiliary device may process the markup and render the content page. Note that this is one example in which the target ID may be the same page ID, with the main computer system or auxiliary device updating the page once per second during the playing of the song with timer data.

Another example of a content page is set forth below:

```
<body>
    <content id=”200” title=”RE: lunch today?” menuid=”1000”>
        <txt wrap=”0”><em>From:</em> Andrew F.</txt>
        <br/>
      <txt wrap=”0”><em>Subject:</em> lunch today?</txt>
      <br/>
      <txt><em>Received:</em> Today, 11:32am</txt>
      <br/>
        <txt><em>Message:</em><br/>Any interest in lunch
        today?</txt>
    </content>
</body>
```

A dialog page essentially comprises a prompt to the user requiring some sort of response. The content of the dialog is primarily text, with the ability to provide an image (limited to a single image in one implementation). A dialog may also contain any practical number of virtual buttons which trigger a response; (a limit may be set on the number of buttons). Depending on the device, some or all of the buttons can be represented onscreen as soft buttons, and/or a navigation map or other indicator that assists the user in selecting a desired button may be displayed.

The following table sets forth example properties of a dialog page:

| | | | |
|---|---|---|---|
| id | Number | Required | The ID number of the current page. |
| | | | This is for reference only. |
| title | String | Optional | The title to be displayed in the |
| | | | title bar or at the top of the |
| | | | page. |
| | | | Default: no title |
| imgid | Number | Optional | The image to use as part of the |
| | | | dialog. The ID is a content ID |
| | | | referring to the image to display. |
| | | | Note that a device does not have to |
| | | | respect this property. |
| | | | Default: no image |

The dialog tag indicates that the page is a dialog, as set forth in the following example markup:

```
<body>
    <dialog id=”300” title=”Power Alert” imgid=”1000”>
        <txt align=”1”>The system has detected that your
        battery is running low. Would you like to go into
        hibernate?</txt>
      <btn key=”Enter” target=”10”>Yes</btn>
      <btn key=”Back” target=”11”>No</btn>
    </dialog>
</body>
```

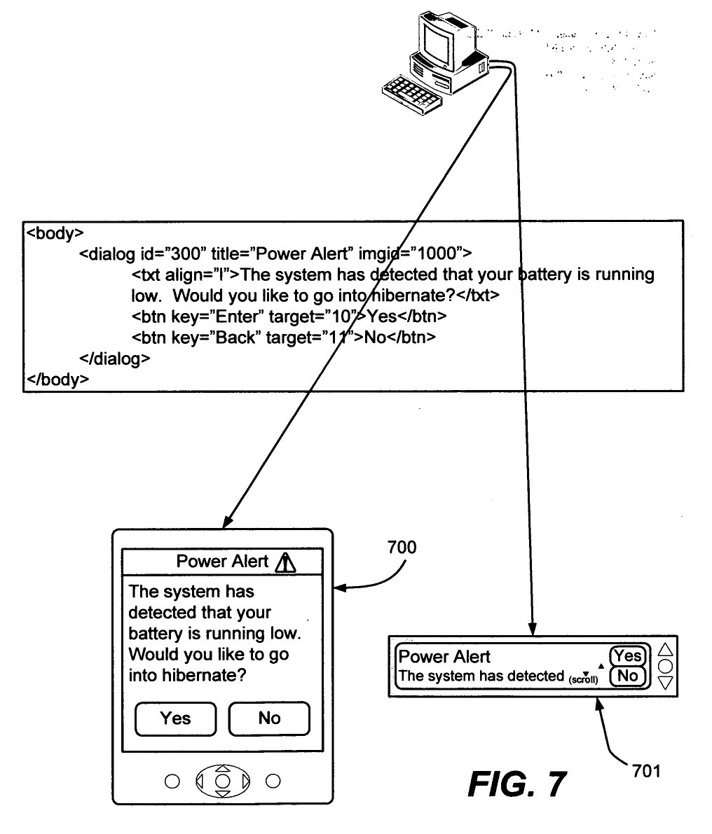

FIG. 7 shows an example of how the example markup above may be rendered on two separate auxiliary displays 700 and 701. Note that in this example, the two-line auxiliary device 701 has decided that the title and buttons should be shown, with the text scrolled by the down arrow, and the current selection between Yes and No toggled by the up arrow. Selection is made by the enter button. In this manner, a device can adapt a page to its own capabilities.

As can be readily appreciated, the basic content format of the present invention provides a solution to displaying content in a number of scenarios. For example, notifications may contain a message, an optional icon and optional response buttons, and thus can be handled via a dialog in the simple content model. For a calendar application, the main page may be presented as a menu, with each menu item being an entry in the calendar. Selecting an item navigates to a content page that contains the full text description of the appointment. Note that a menu item selection may cause display of another menu page. The following is an example of another menu page that may be displayed, such as upon selecting the calendar item in FIG. 5:

```
<body>
    <menu id=”300” title=”Today's Appointments”>
        <item target=”11” imgid=”1” menuid=”50”>10:00a-11:00a
        Design Meeting</item>
        <item target=”12” imgid=”1” menuid=”50”>11:30a-1:00p
        Team Lunch</item>
        <item target=”13” imgid=”1” menuid=”50”>3:00p-4:00p
        Pick up kids</item>
    </menu>
</body>
```

Another example is a presentation (e.g., Microsoft® PowerPoint remote control application, in which the main page comprises a menu containing options to open or start a presentation. Once a presentation is started, the page may comprise another menu containing a list of the slides and their titles. Selecting a particular menu item would navigate to that slide. Additionally, it may bring up a content page for that slide containing the speaker's notes and other pertinent information, including potentially a thumbnail image.

It should be noted that while pages are typically configured by an application program running on the main computer system, this is not a requirement. Indeed, the page may be persisted such as in a file, and thus any transfer medium that the auxiliary device can access may be written with a page. Thus, for example, a page can be communicated from one auxiliary device to another. Also, a page may be written by one application running on the auxiliary device for another application running on the same device.

Turning to a consideration of events, in the course of user-interaction with an application displaying the simple content format, a number of events may be generated as generally described above. Events include navigation events, menu action events, and context menu events.

In one implementation, a navigation event (NavigationEvent, [Event ID=1]) is triggered upon any navigation starting on a content or dialog page. On a dialog page, each button (btn) element references a different virtual key. Event parameters include:

| | |
|---|---|
| CONTENT_ID | PreviousPage; |
| CONTENT_ID | TargetPage; |
| UINT32 | Button; |

The PreviousPage parameter comprises the content ID of the page on which the navigation was triggered. The TargetPage is the content ID of the page to which the system navigates. The Button is an enumeration value representing the button which caused the navigation to occur.

A menu action event (MenuActionEvent [Event ID=2]) is triggered upon any navigation from a menu page to any page, except the loading of a context menu. In this implementation, event parameters include:

| | |
|---|---|
| CONTENT_ID | PreviousPage; |
| CONTENT_ID | TargetPage; |
| UINT32 | Button; |
| UINT32 | ItemId; |

The PreviousPage parameter is the content ID of the page on which the navigation was triggered. The TargetPage is the content ID of the page to which the system navigates. The Button is the enumeration value representing the button which caused the navigation to occur. The ItemId is the id value associated with the selected item on which the navigation occurred.

A context menu event (ContextMenuEvent [Event ID=3]) event is triggered upon any navigation from a context menu. Context menus are treated specially because of additional information associated with each context menu, that is, the context in which it was invoked. In one implementation, this is represented by the event parameters:

| | |
|---|---|
| CONTENT_ID | PreviousPage; |
| CONTENT_ID | TargetPage; |
| UINT32 | PreviousItemId; |
| CONTENT_ID | MenuPage; |
| UINT32 | MenuItemId; |

The PreviousPage parameter is the content ID of the page on which the context menu was originally invoked; it can reference any type of page. The TargetPage is the content ID of the page which is navigated to as a result of selecting an item in the context menu. The PreviousItemId is the menu item id, if any, that was selected when the context menu was invoked. This parameter is only valid if the previous page was a menu, and the menu item had an id associated with it. If neither of those is true, this parameter is set to 0. The MenuPage is the content ID of the context menu. The MenuItemId is the id value, if any, associated with the selected context menu item on which the navigation occurred. If none is specified, the value is 0.

The following sets forth an example schema for the simple content format:

```
<?xml version=“1.0” ?>
<xsd:schema xmlns:xsd=“http://www.w3.org/2001/XMLSchema”>
  <!-- General element related types -->
  <xsd:simpleType name=“Alignment”>
    <xsd:restriction base=“xsd:string”>
      <xsd:pattern value=“l|r|c” />
    </xsd:restriction>
  </xsd:simpleType>
  <xsd:simpleType name=“ColorRGB”>
    <xsd:restriction base=“xsd:hexBinary”>
      <xsd:minLength value=“1” />
      <xsd:maxLength value=“6” />
    </xsd:restriction>
  </xsd:simpleType>
  <!-- Image element related types -->
  <xsd:simpleType name=“ImageFit”>
    <xsd:restriction base=“xsd:string”>
      <xsd:pattern value=“native|width|screen|auto” />
    </xsd:restriction>
  </xsd:simpleType>
  <!-- Text element related types -->
  <xsd:simpleType name=“TextWrap”>
    <xsd:restriction base=“xsd:nonNegativeInteger”>
      <xsd:minInclusive value=“0” />
      <xsd:maxInclusive value=“1” />
    </xsd:restriction>
  </xsd:simpleType>
  <!-- Button element related types -->
  <xsd:simpleType name=“ButtonKey”>
    <xsd:restriction base=“xsd:string”>
      <xsd:pattern value=“enter|back|home|left|right|up|down” />
    </xsd:restriction>
  </xsd:simpleType>
  <!-- Item element related types -->
  <xsd:simpleType name=“MenuItemDefault”>
    <xsd:restriction base=“xsd:nonNegativeInteger”>
      <xsd:minInclusive value=“0” />
      <xsd:maxInclusive value=“1” />
    </xsd:restriction>
  </xsd:simpleType>
  <xsd:simpleType name=“MenuItemEnabled”>
    <xsd:restriction base=“xsd:nonNegativeInteger”>
      <xsd:minInclusive value=“0” />
      <xsd:maxInclusive value=“1” />
    </xsd:restriction>
  </xsd:simpleType>
  <!-- Content element related types -->
  <xsd:simpleType name=“ContentBackgroundFitMode”>
    <xsd:restriction base=“xsd:string”>
      <xsd:pattern value=“s|t|c” />
    </xsd:restriction>
  </xsd:simpleType>
  <!-- Element groupings -->
  <xsd:group name=“DialogChild”>
    <xsd:choice>
      <xsd:element ref=“txt” minOccurs=“1” />
      <xsd:element ref=“btn” minOccurs=“1” />
    </xsd:choice>
  </xsd:group>
  <xsd:group name=“MenuChild”>
    <xsd:choice>
      <xsd:element ref=“item” minOccurs=“1” />
      <xsd:element ref=“div” />
    </xsd:choice>
  </xsd:group>
  <xsd:group name=“ContentChild”>
    <xsd:choice>
      <xsd:element ref=“txt” />
      <xsd:element ref=“br” />
      <xsd:element ref=“img” />
      <xsd:element ref=“btn” />
    </xsd:choice>
  </xsd:group>
  <xsd:group name=“TopLevel”>
      <xsd:choice>
      <xsd:element ref=“content” />
      <xsd:element ref=“menu” />
      <xsd:element ref=“dialog” />
    </xsd:choice>
  </xsd:group>
  <!-- Schema elements -->
  <xsd:element name=“body”>
    <xsd:complexType>
      <xsd:group ref=“TopLevel” />
    </xsd:complexType>
  </xsd:element>
  <xsd:element name=“img”>
    <xsd:complexType>
      <xsd:attribute name=“id” type=“xsd:positiveInteger”
use=“required” />
      <xsd:attribute name=“align” type=“Alignment” use=“optional” />
      <xsd:attribute name=“fit” type=“ImageFit” use=“optional” />
      <xsd:attribute name=“alt” type=“xsd:string” use=“optional” />
    </xsd:complexType>
  </xsd:element>
  <xsd:complexType name=“EmphasisType” mixed=“true”>
    <xsd:sequence minOccurs=“0” maxOccurs=“unbounded”>
      <xsd:element ref=“clr” />
    </xsd:sequence>
  </xsd:complexType>
  <xsd:complexType name=“ColorType” mixed=“true”>
    <xsd:sequence minOccurs=“0” maxOccurs=“unbounded”>
      <xsd:element ref=“em” />
    </xsd:sequence>
    <xsd:attribute name=“rgb” type=“ColorRGB” use=“required” />
  </xsd:complexType>
  <xsd:element name=“em” type=“EmphasisType” />
  <xsd:element name=“clr” type=“ColorType” />
  <xsd:group name=“Text”>
    <xsd:choice>
      <xsd:element ref=“em” />
      <xsd:element ref=“clr” />
      <xsd:element ref=“br” />
    </xsd:choice>
  </xsd:group>
  <xsd:complexType name=“TextType” mixed=“true”>
    <xsd:group ref=“Text” minOccurs=“0” maxOccurs=“unbounded” />
    <xsd:attribute name=“align” type=“Alignment” use=“optional” />
    <xsd:attribute name=“wrap” type=“TextWrap” use=“optional” />
    <xsd:attribute name=“rgb” type=“ColorRGB” use=“optional” />
  </xsd:complexType>
  <xsd:element name=“txt” type=“TextType” />
  <xsd:element name=“br”>
    <xsd:complexType />
  </xsd:element>
  <xsd:element name=“div”>
    <xsd:complexType />
  </xsd:element>
  <xsd:element name=“btn”>
    <xsd:complexType>
      <xsd:simpleContent>
      <xsd:extension base=“xsd:string”>
          <xsd:attribute name=“key” type=“ButtonKey”
          use=“required” />
          <xsd:attribute name=“target” type=“xsd:positiveInteger”
use=“required” />
        </xsd:extension>
      </xsd:simpleContent>
    </xsd:complexType>
  </xsd:element>
  <xsd:element name=“content”>
    <xsd:complexType>
      <xsd:group ref=“ContentChild” maxOccurs=“unbounded” />
      <xsd:attribute name=“id” type=“xsd:positiveInteger”
use=“required” />
      <xsd:attribute name=“title” type=“xsd:string” use=“optional” />
      <xsd:attribute name=“bg” type=“xsd:positiveInteger”
use=“optional” />
      <xsd:attribute name=“bgfit” type=“ContentBackgroundFitMode”
use=“optional” />
      <xsd:attribute name=“menuid” type=“xsd:positiveInteger”
use=“optional” />
    </xsd:complexType>
    <xsd:unique name=“UniqueButtonKeyContent”>
      <xsd:selector xpath=“./btn” />
      <xsd:field xpath=“@key” />
    </xsd:unique>
  </xsd:element>
  <xsd:element name=“item”>
    <xsd:complexType name=“ItemType” mixed=“true”>
      <xsd:sequence minOccurs=“0” maxOccurs=“unbounded”>
        <xsd:element ref=“br” />
      </xsd:sequence>
      <xsd:attribute name=“id” type=“xsd:positiveInteger”
use=“optional” />
      <xsd:attribute name=“target” type=“xsd:positiveInteger”
use=“required” />
      <xsd:attribute name=“imgid” type=“xsd:positiveInteger”
use=“optional” />
      <xsd:attribute name=“def” type=“MenuItemDefault”
use=“optional” />
      <xsd:attribute name=“enable” type=“MenuItemEnabled”
use=“optional” />
      <xsd:attribute name=“menuid” type=“xsd:positiveInteger”
use=“optional” />
    </xsd:complexType>
    <xsd:unique name=“UniqueId”>
      <xsd:selector xpath=“./item” />
      <xsd:field xpath=“@id” />
    </xsd:unique>
  </xsd:element>
  <xsd:element name=“menu”>
    <xsd:complexType>
      <xsd:group ref=“MenuChild” maxOccurs=“unbounded” />
      <xsd:attribute name=“id” type=“xsd:positiveInteger”
use=“required” />
      <xsd:attribute name=“title” type=“xsd:string” use=“optional” />
    </xsd:complexType>
  </xsd:element>
  <xsd:element name=“dialog”>
    <xsd:complexType>
      <xsd:group ref=“DialogChild” maxOccurs=“unbounded” />
      <xsd:attribute name=“id” type=“xsd:positiveInteger”
use=“required” />
      <xsd:attribute name=“title” type=“xsd:string” use=“optional” />
      <xsd:attribute name=“imgid” type=“xsd:positiveInteger”
use=“optional” />
    </xsd:complexType>
    <xsd:unique name=“UniqueButtonKeyDialog”>
      <xsd:selector xpath=“./btn” />
      <xsd:field xpath=“@key” />
    </xsd:unique>
  </xsd:element>
</xsd:schema>
```

As can be seen from the foregoing, the present invention provides a simple content format for communicating data to an auxiliary display platform. The content format provides a reasonably good user experience between various device implementations by rendering reasonably well across devices with differing capabilities, yet still providing flexibility and enough information for limited devices to know how to best present the display. The present invention thus provides numerous benefits and advantages needed in contemporary computing.

While the invention is susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions, and equivalents falling within the spirit and scope of the invention.

What is claimed is:

1. In a computing environment, a method comprising:
arranging data according to a format that allows an auxiliary display device to display a representation of the data based on its capabilities, including marking each set of data with information that indicates a type of data, and marking the data with any desired formatting instructions; and
providing the data to a transfer medium for access by the auxiliary display.

2. The method of claim 1, further comprising, arranging the data as a page, and marking the data with a page type.

3. The method of claim 1, wherein marking the data with the page type comprises marking the data as corresponding to a menu page, and wherein arranging the data further comprises, including at least one selectable item within the menu page, and providing information corresponding to a button for selecting an item.

4. The method of claim 1, wherein marking the data with the page type comprises marking the data as corresponding to a content page, and wherein arranging the data further comprises, including text within the content page.

5. The method of claim 1, wherein arranging the data further comprises, including an image within the content page.

6. The method of claim 1, wherein marking the data with the page type comprises marking the data as corresponding to a dialog page, and wherein arranging the data further comprises, including an actionable option within the content page, and providing information corresponding to a button for selecting the option.

7. The method of claim 1, wherein marking the content comprises placing a markup language tag in the content.

8. The method of claim 1, further comprising, receiving an event, and navigating to a target page based on the event.

9. A computer-readable medium having computer-executable instructions, which when executed perform the method of claim 1.

10. A computer-readable medium having stored thereon a data structure, comprising:
an indicator of a page type;
text content corresponding to the page type;
formatting information, the information corresponding to the text content; and
wherein an auxiliary device interprets the data structure and determines a way to present the text based on capabilities of the device.

11. The computer-readable medium of claim 10, wherein the page type corresponds to at least one type of a set of types, the set comprising, a menu page type, a dialog page type, and a content page type.

12. The computer-readable medium of claim 10, wherein the formatting information corresponds to at least one request of a set of requests, the set comprising, an emphasis request, a color request, an alignment request, and a wrap request.

13. The computer-readable medium of claim 10, further comprising, image data, wherein an auxiliary device interprets the data structure and determines a way to present the image data based on capabilities of the device.

14. The computer-readable medium of claim 13, wherein the formatting information corresponds to at least one request of a set of requests, the set comprising, an alignment request, and a fit request.

15. In a computing environment, a system comprising:
a program that generates a page of content, the page having text to render and formatting information; and
an auxiliary display device, including means for processing the page and rendering a representation of the page, including formatting the text based on the formatting information, the auxiliary display device further including means for generating events corresponding to navigating to another page.

16. The system of claim 15 further comprising another auxiliary display device, the other auxiliary display device including means for processing the page and rendering a representation of the page, in which at least some of the formatting information is not used to format the text.

17. The system of claim 15 wherein the page includes a target page and information corresponding to a button, and wherein the auxiliary display device navigates to the target page upon detection of actuation of the button.

18. The system of claim 15 wherein the page corresponds to at least one type of a set of types, the set comprising, a menu page type, a dialog page type, and a content page type.

19. The system of claim 15 wherein the formatting information corresponds to at least one request of a set of requests related to the text, the set comprising, an emphasis request, a color request, an alignment request, and a wrap request.

20. The system of claim 15 wherein the page includes image data, and wherein the formatting information corresponds to at least one request of a set of requests related to the image data, the set comprising, an alignment request, and a fit request.
